(19) United States
(12) Patent Application Publication
(10) Pub. No.: US 2005/0118919 A1
(43) Pub. Date: Jun. 2, 2005

(54) Flame blocking liner materials

(76) Inventors: Eberhard Link, Creedmoor, NC (US); Charles R. Mason, Nashua, NH (US); Amelia Tosti, Nashua, NH (US); Ashutosh Karnik, Andover, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/914,719

(22) Filed: Aug. 9, 2004

Related U.S. Application Data
(63) Continuation-in-part of application No. 10/262,133, filed on Oct. 1, 2002.

(51) Int. Cl. B27N 9/00

(52) U.S. Cl. 442/414; 442/327; 442/415; 442/402; 428/920; 428/921

(57) ABSTRACT

A fire blocking non-woven needle-punched textile structure, comprising a first fiber component containing polyacrylonitrile copolymer with a halogen containing monomer, a second fiber component comprising a viscose fiber containing silicic acid or a regenerated cellulose fiber and a third fiber component comprising an aramid fiber or a melamine/formaldehyde fiber or a polyester fiber.

### CROSS-REFERENCE TO RELATED APPLICATIONS

This application is a continuation-in-part of U.S. application Ser. No. 10/262,133, filed Oct. 1, 2002.

### FIELD OF THE INVENTION

This invention relates to fire resistant needle punched materials and to their methods of preparation. The invention has particular utility in the formation of fire blocking fabric as a liner under upholstery fabric and mattress ticking. The invention also has utility for the production of fire resistant vertical lapped batting material.

### BACKGROUND OF THE INVENTION

As noted in U.S. Pat. No. 6,287,690, it is well known in the textile industry to produce fire resistant fabrics for use as upholstery, mattress ticking, panel fabric, etc., using yarn formed of natural or synthetic fibers, and then treating the fabric with fire retardant chemicals. Conventional fire retarding chemicals include halogen-based and/or phosphorous-based chemicals. Such treated fabrics reportedly are heavier than similar types of non-fire retardant fabrics, and are said to have a more limited wear life.

The incidence of mattress fires in the United States is such that there have been efforts to establish standards for testing open flame flammability of mattresses. California, e.g., has enacted regulations in 2001 which requires all mattresses to be sold effective January 2005 to meet the performance requirements of California Technical Bulletin 603. This is a consequence, among other things, of the fact that the foam used in mattresses can be a source of fuel which can be ignited and quickly engulf the mattress in flames.

Not surprisingly, therefore, one can uncover numerous disclosures aimed at modifying the burning characteristics of fiber materials. For example, in U.S. Pat. No. 4,600,606 a method of flame retarding textile and related fibrous materials is reported, which relies upon the use of a water-insoluble, non-phosphorous containing brominated aromatic or cycloaliphatic compounds along with a metal oxide. U.S. Pat. No. 4,026,808 reports on the use of a phosphorous containing N-hydroxy-methyl amide and tetrakis(hydroxymethyl) phosphonium chloride. U.S. Pat. No. 3,955,032 confirms the use of chlorinated-cyclopentadieno compounds, chlorobrominated-cyclpentadieno compounds, either alone or in combination with metal oxides.

U.S. Pat. No. 4,702,861 describes a flame retardant composition for application as an aqueous working dispersion onto surfaces of combustible materials. Upon exposure to elevated temperatures and/or flame, the formulation reportedly creates a substantially continuous protective film generally encapsulating and/or enveloping the surface of the article onto which it is applied. The film-forming materials are based upon an aqueous latex dispersion of polyvinylchloride-acrylic copolymer together with certain other film-forming and viscosity controlling components.

Other disclosures which offer additional background information include U.S. Pat. No. 4,776,854 entitled “Method for Flameproofing Cellulosic Fibrous Materials”; U.S. Pat. No. 5,051,111 entitled “Fibrous Material”; U.S. Pat. No. 5,569,528 entitled “Treating Agent for Cellulosic Textile Material and Process for Treating Cellulosic Textile Material”; and U.S. Pat. No. 6,309,565 entitled “Formaldehyde-Free Flame Retardant Treatment for Cellulose-Containing Materials”.

It is also worth mentioning that within the various efforts to provide flame resistant fabric products, various polymers themselves have emerged as substrates for use as flame resistant fibers. For example, melamine and melamine/formaldehyde based resinous fibers are said to display desirable heat stability, solvent resistance, low flammability and high-wear characteristics. One form of melamine/formaldehyde fiber is marketed under the tradename Basofil™. In addition, the aromatic polyamide family or aramids reportedly have high strength, toughness, and thermal stability. Aramid fibers are marketed under the tradenames Nomex™ and Kevlar™.

Furthermore, acrylic fibers are well-known in the synthetic fiber and fabric industries, as are the modified acrylic fibers (modacrylic). Such modacrylics are relatively inexpensive, and have been used in various blends with the fibers noted above to provide fire-resistant fabric material. One particular modacrylic fiber is sold under the tradename Kanecaron™ Protex, which is available from Kaneka Corporation, Japan.

In addition, flame retardant viscose fibers have become available, and one particular viscose fiber is sold under the tradename Visil™ . More specifically, Visil™ is said to comprise a silicic acid containing viscose, with a limiting oxygen index (i.e., the minimum concentration of oxygen necessary to support combustion) in the range of 27-35, depending upon a particular textile construction.

Finally, it is worth noting that various manufacturers have produced and sold fire-resistant fabric material. They are as follows: 1. E. R. Carpenter's “Fire Stop™M”, which relies upon Basofil™/modacrylic high loft batting; 2. Chiquola Industrial Fabric's “FireGuard™” which relies upon core spun flame retardant yarns into woven or knit form; 3. ChemTick Coated Fabrics “Flame Safe™” which relies upon core spun yarn in woven configuration with flame retardant treatment; 4. Elk Corporation's “VersaShield™” which relies upon a woven fiberglass base with a soft foam like coating on one side; 5. Jones Fiber Products, Inc.'s “T-Bond™” which relates to a flame retardant treatment of cotton batting; 6. Legett & Platt's “Pyro-Gon™” which is a batting of a blend of Pyron (panox) fibers with other fibers; 7. MLM, LLC's “Allesandra” which is a core spun flame retardant yarn in woven form; 8. Tex Tech's various blends of Basofil™ and Nomex™, Kevlar™ and PBI in the form of needlepunched felts; and 9. Ventex's “Integrity 30™”, SpunGold™ and AKTIV™ which collectively relate to various products of knits and non-woven battings that may include Basofil™, Panox, Kevlar™ or Nomex™.

It is therefore an object of the present invention to expand upon the technology directed at the manufacture of flame retardant materials, and develop a fire resistant needle punched material that can serve, among other things, as a protective liner material. More specifically, it is an object of the present invention to develop new types of needle punched materials that rely upon a foundation component of a modified acrylic type fiber that is based upon a copolymer of polyacrylonitrile and a halogen based monomer to provide an inexpensive fire blocking composition.

It is also an object of the present invention to provide a fire-resistant material which relies upon a needle punched non-woven manufacture of two principal components, wherein one component is selected to provide non-burning characteristics, and a second component is selected to support and maintain the first component in place during burning as well as to provide non-burning characteristics, thereby resulting in a synergistic composition that reduces the burn rate in a given liner application.

### SUMMARY OF THE INVENTION

In a first embodiment, the present invention comprises a fire blocking non-woven needlepunched textile structure, comprising a first fiber component containing polyacrylonitrile copolymer with a halogen containing monomer and a second fiber component, wherein said second fiber component supports said first fiber component during burning, optionally including inorganic filler as a coating for said first and second fiber components.

In a second embodiment, the invention herein comprises a fire blocking non-woven textile structure, in the form of vertical lapped batting, comprising a first fiber component containing polyacrylonitrile copolymer with a halogen containing monomer and a second fiber component, wherein said second fiber component comprises a viscose fiber containing silicic acid and/or a melamine-formaldehyde polymer, and a third fiber component comprising a binder fiber having the capability to melt bond said first and second components wherein said first and second components are melt bonded together by said binder fiber.

In a third embodiment, the invention herein comprises a fire blocking non-woven textile structure, comprising a first fiber component containing polyacrylonitrile copolymer with a halogen containing monomer and a second fiber component such as a viscose fiber containing silicic acid and/or a regenerated cellulose fiber and a third fiber component such as an aramid fiber or a melamine/formaldehyde fiber. Optionally, one may also include a polyester fiber component, such as an aromatic polyester such as poly(ethylene terephthalate) (PET) which can also be employed to replace the aramid or melamine/formaldehyde component. In addition, optionally, one may also employ a binder fiber having the ability to melt bond with all the fiber components.

In a fourth embodiment, the invention herein comprises a fire blocking non-woven textile structure that is strategically located on a foam-containing article to provide fire blocking performance. Accordingly, the invention comprises a fire blocking non-woven textile cover for a foam containing article such as a mattress wherein the mattress contains horizontal and vertical sections, and wherein said cover includes a horizontal section comprising a fire blocking non-woven textile structure made from polyacrylonitrile copolymer with a halogen containing monomer and a second fiber component. The second fiber component supports said first fiber component during burning, and the non-woven textile structure for such horizontal section of the mattress optionally includes inorganic filler as a coating or saturant for the first and second fiber components. The second fiber component may include a viscose fiber containing silicic acid and/or a melamine/formaldehyde polymer and/or a polyester component. The cover also includes a vertical cover section for the vertical sections of the mattress and comprises a first fiber component containing polyacrylonitrile copolymer with a halogen containing monomer and a second fiber component such as a viscose fiber containing silicic acid and/or a melamine formaldehyde polymer and a third fiber component such as an aramid fiber.

In a fifth embodiment, the present invention is directed at a fire blocking non-woven textile structure, comprising a needle-punched web including an aramid fiber, wherein said needle punched web including an aramid fiber is attached or needle-punched with a spunbond or melt blown or spunbond/melt blown web material.

In a sixth embodiment the present invention is directed at a fire blocking non-woven needle-punched textile structure, comprising a first carded web including an aramid and/or melamine/formaldehyde fiber and a second carded web comprising a blend of polyacrylonitrile copolymer with a halogen comonomer and a polyester polymer, wherein said first carded web including aramide and/or melamine/formaldehyde fiber is needle punched with said second carded web of said blend. The aramid and/or melamine/formaldehyde fiber in the first carded web may be present at levels of greater than or equal to 10% (wt.), and the first carded web may also comprise, e.g. 5-25% (wt.) of aramid fiber in combination with 95-75% (wt.) of a viscose fiber containing silicic acid or 5-25% (wt.) of melamine/formaldehyde fiber in combination with 95-25% (wt.) of a viscose fiber containing silicic acid.

In a seventh embodiment the present invention is directed at a fire blocking non-woven textile structure comprising a first carded web including an aramide and/or melamine/formaldehyde fiber and a second carded web comprising a blend of a binder fiber and a polyester fiber, wherein said first carded web contacts said second carded web of said blend. The aramid and/or melamine/formaldehyde fiber in the first carded web may be present at levels of greater than or equal to 10% (wt.), and the first carded web may also comprise, e.g. 5-25% (wt.) of aramid fiber in combination with 95-75% (wt.) of a viscose fiber containing silicic acid or 5-25% (wt.) of melamine/formaldehyde fiber in combination with 95-25% (wt.) of a viscose fiber containing silicic acid. Optionally, the second carded web may further include natural fibers (fibers made from animals, vegetables or minerals, such as wool, cotton, silk, etc) and/or polyacrylonitrile copolymer with a halogen comonomer.

### BRIEF DESCRIPTION OF THE DRAWINGS

FIG. 1 is a flow-chart illustrating an embodiment of the invention for forming a needle-punched fire-blocking material of the present invention.

FIG. 2 is a flow-chart again illustrating an embodiment of the invention for forming a needle-punched fire-blocking material of the present invention.

### DETAILED DESCRIPTION OF THE PREFERRED EMBODIMENTS

In the first embodiment, the fire resistant non-woven material of the present invention, which can be used as a protective liner material, is preferably manufactured from a needle-punched combination of modacrylic fiber with a second fiber component which may comprise a viscose fiber containing silicic acid and or a melamine/formaldehyde polymer. Optionally, and as described in more detail below, an inorganic filler such as vermiculate may be included as a coating. Other inorganic fillers include those selected from the group consisting of graphite, fumed silica or silica dioxide, or titanium dioxide, and mixtures thereof.

It should be noted that at least one factor contributing to the performance of this first embodiment, as a unique fire resistant non-woven material, is the modacrylic fiber. When the modacrylic is activated by heat, it apparently assists in the displacement of oxygen thereby reducing heat release and bum rate. Furthermore, the vermiculate coating may then serve to disperse the heat across the needlepunch fabric. However, the invention herein is not limited to any particular theorized functionality of the individual components and relies upon the various combinations that are ultimately described in the appended claims.

The modacrylic fiber is preferably based upon a polyacrylonitrile copolymer with a halogen containing comonomer, and the halogen containing comonomer is preferably poly(vinyl chloride) or poly(vinylidine chloride). A preferred modacrylic fiber is available form Kaneka Corporation, under the tradename Kanecaron™ Protex. In a most preferred embodiment, the modacrylic employed herein is sold under the tradename Kanecaron™ Protex PBX, at a specific gravity of 1.45-1.60 with a fiber denier of 2.2 dtex×38 mm. Protex PBX is described as having the following chemical components: acrylonitrile, vinylidine chloride copolymer, antimony oxide. A preferred viscose fiber containing silicic acid is sold under the tradename Visil™, available from Sateri Oy Inc. The Visil fiber is type AP 33 3.5 dtex×50 mm. It is composed of 65-75% regenerated cellulose, 25-35% silicic acid, and 2-5% aluminum hydroxide. A preferred melamine/formaldehyde fiber component is sold under the tradename Basofil™, available from McKinnon-Land-Moran, LLC.

Preferably, the non-woven material will also have a basis weight of 100-500 g/m², including all increments therebetween at 1 g/m² variation.

The above referenced fire blocking non-woven textile therefore may preferably contain the modacrylic polymer component (e.g., polyacrylonitrile copolymer with poly(vinylidine chloride)) at levels of about 30-80% (wt.), and correspondingly, the second fiber component which supports the modacrylic component may be present at about 20-70% (wt.). In a particularly preferred embodiment, the modacrylic component is present at about 80% (wt.) and the second fiber component is preferably a viscose fiber containing silicic acid and/or a melamine/formaldehyde polymer which is present at about 20% (wt.). In the context of all of these preferred ranges, it should be understood that within the broad scope of this invention, all increments therebetween are included, at 1% (wt) variation.

While not being bound by any particular theory, it has been observed that in the context of the above needle punched non-woven structure, the second fiber component serves to support the first fiber component during burning. By “support” it is meant that the second fiber maintains the first fiber component in place thereby reducing the tendency of the first fiber component to undergo shrinkage during burning, which shrinkage will sacrifice considerably the fire blocking performance. Accordingly, the combination of the first and second fiber components, through the needle punching operation, allows for the development of an relatively inexpensive fire blocking composition which can be readily applied as a fire blocking fabric liner under upholstery fabric and mattress ticking, thereby protecting the more flammable interior components of such products from igniting and participating in the burning process.

In addition, and again, without being bound by any particular theory of operation, it is also believed that the selective use of the modacrylic fibers herein, that preferably rely upon a copolymer of polyacrylonitrile and a poly(vinylidine chloride) copolymer structure, releases hydrochloric gas during the burning process. It is believed that the hydrochloric gas then assists in controlling the bum rate, providing another overall synergistic feature with respect to the above disclosed strategic selection of the individual components. Also, when combustion temperatures exceed 600° F., oxyhalides are formed which take up the free radicals formed in the vapor phase.

Furthermore, as noted above, it is preferable that the above non-woven include an inorganic filler, e.g. vermiculite as a coating or saturant component. Vermiculate is reference to one of the mica groups that are used as granular fillers, and comprise a crystalline layer silicate material. However, some of the silicon atoms are replaced with aluminum, producing a negative charge that is neutralized by the interlayer cations, mostly magnesium. The vermiculite particles are of a planer structure consisting of platelets that have a minimum 400:1 xy plane to z plane ratio. Preferably, the level of vermiculate herein, as a coating in the non-woven, is about 20-40g/m², including all increments therebetween at 1.0 g/m² variation.

In accordance with the above embodiment, the fire blocking non-woven material is preferably of a thickness of: 1.5-25 mm, including all increments therebetween at 1.0 mm variation.

In a second preferred embodiment, the above non-woven textile is further modified, in the sense that the concentration of the first and second fiber components are reduced in favor of the use of a binder polymer fiber. Such binder polymer fiber has the capability to melt bond with the first and second fiber components. The preferred binder fiber is 4d×2″ from either Nan Ya or Sam Yang in Korea with the outer layer having a melting point of 150° C. which melting point is lower than the melting point of the inner layer of this particular binder fiber material. Furthermore, in this embodiment the first component modacrylic fiber is first blended with the second fiber component (viscose fiber containing silicic acid and/or melamine/formaldehyde polymer) as well as the bicomponent polymer fiber noted above. The three fibers are blended together, formed into a web which is then vertically lapped and then bonded in a hot air oven as the final process. The binder fiber outer layer melts and flows onto the other fibers which bonds the structure together.

Elaborating upon the above, and in the broad context of the present invention, the binder fibers of the present invention may include one or plurality of polymer components. In addition, the binder fiber may be in the form of a sheath/core, side by side, or monofilament configuration.

In accordance with the above, the modacrylic fiber component is present at a level of about 50-70% (wt.), the second fiber component is present at a level of about 10-20% (wt.) and the binder fiber is present at a level of about 10-30% (wt.). Again, as noted above, it should be understood that in the context of the present invention, all increments therebetween are included at 1% (wt) variation. Furthermore, such composition preferably is prepared at a basis weight of 100-500 g/m², and at all 1.0 g/m² increments.

As noted above, the invention herein is further directed and has been expanded to include a fire blocking non-woven needle-punched textile structure comprising the following fiber components: 1. a first fiber component containing polyacrylonitrile copolymer with a halogen containing monomer; 2. a second fiber component, preferably a viscose fiber containing silicic acid and/or a regenerated cellulose fiber prepared from wood pulp (e.g. lyocell fiber); and 3. a third fiber component comprising an aramid fiber or a polyester fiber.

Preferably, the aramid fiber is reference to an aromatic polyamide type fiber material, such as a poly (p-phenylene terephthalamide) made by E. I. DuPont de Nemours & Co. and sold as KEVLAR®. Preferably, the aramid fiber is present at a level of less than or equal to 60.0% wt., including all percentages and ranges therein. In addition, reference herein to a viscose fiber is general reference to a fiber produced by the viscose process in which cellulose is chemically converted into a compound for ultimate formation into a fiber material. Regenerated cellulose is general reference to cellulose that is first converted it into a form suitable for fiber preparation (e.g. xanthation) and regenerating the cellulose into fiber form.

In addition, preferably, the fiber denier of the fibers of such textile structure may be configured in the range of about 1-15 denier, including all increments and ranges therebetween. In addition, the basis weight of any such fire blocking textile structure may be in the range of about 100-350 g/m². In addition, optionally, one may employ a binder fiber which as noted herein, comprises one or a plurality of fiber components, in either a sheath/core, side-by-side or monofilament configuration.

Expanding on the above, it is worth noting that the preferred use of the lyocell fiber herein is broadly defined herein as one example of a synthetic fiber produced from cellulosic substances. Lyocell is reportedly obtained by placing raw cellulose in an amine oxide solvent, the solution is filtered, extruded into an aquqous bath of dilute amine oxide, and coagulated into fiber form. From a property perspective, lyocell is also described as being a relatively soft, strong and absorbent fiber, with excellent wet strength, that happens to be wrinkle resistance, dyable to a number of colors, simulating silk or suede, with good drapability.

Accordingly, in the context of the present invention, the first fiber component (polyacrylonitrile copolymer with halogen containing monomer) may be preferably present in an amount of 30-60% wt., the second fiber component (viscose fiber containing silicic acid such as Visil™ or Lyocell fiber) may be present in an amount of 20-50% wt., and the aramid fiber may be present in an amount of 10-20% wt. All percentage values and ranges therein are also contemplated in the context of the present invention. Some exemplary formulations may therefore be as follows:

### EXAMPLE I

| | |
|---|---|
| PAN copolymer | 40% wt. (7.0 Denier) |
| Visil ™ | 40% wt. (4.5 Denier) |
| PET | 20% wt. (6.0 Denier) |

### EXAMPLE II

| | |
|---|---|
| PAN copolymer | 40% wt. (7.0 Denier) |
| Lyocell fiber | 40% wt. (3.0 Denier) |
| PET | 20% wt. (6.0 Denier) |

In addition, as noted, the invention herein also recognizes that with respect to foam-containing articles, such as a mattress, sofa cushion or pillow, it is important to provide such products in a fashion where there is protection against the flammability characteristics of the foam contained within such products. On that note it can be appreciated that with respect to California Technical Bulletin 603, entitled “Requirements and Test Procedure for Resistance of a Mattress/Box Spring Set to a Large Open Flame”, the purpose of such test is to determine the burning behavior of mattresses by measuring specific fire-test responses when the mattress is subjected to a specified flaming ignition source under ventilated conditions. It is stated that a mattress is considered to have failed the requirements of the test procedure if any of the following criteria are exceeded: 1. a peak rate of heat release of 200 kW within 30 minutes and 2. a total heat release of 25 MJ in the first 10 minutes of the test.

Accordingly, it has been appreciated herein that given the fact that a foam-containing article such as a mattress, will have different burning characteristics either in the mattress vertical panel section or mattress horizontal panel section, one can selectively provide a fire-blocking non-woven needle punched cover structure which strategically provides more flame resistant characteristics to the vertical section of the mattress where burning tends to be a more serious problem. Accordingly, the invention herein provides a fire blocking non-woven needle-punched textile cover structure for a foam-containing article such as a mattress, wherein said mattress has a substantially vertical panel section and a substantially horizontal panel section, wherein said cover structure includes horizontal and vertical panel cover sections. The vertical cover section preferably comprises a first fiber component containing polyacrylonitrile copolymer with a halogen containing monomer and a second fiber component comprising a viscose fiber containing silicic acid and a third fiber component comprising an aramid fiber. The vertical cover section may also include a first carded web including an aramid and/or melamine/formaldehyde fiber and a second carded web comprising a blend of polyacrylonitrile copolymer with a halogen comonomer and a polyester polymer, wherein said first carded web including aramid and/or melamine/formaldehyde fiber is needle punched with said second carded web of said blend

The horizontal panel cover section comprises a first fiber component containing polyacrylonitrile copolymer with a halogen containing monomer and a second fiber component comprising a viscose fiber containing silicic acid and a third fiber component comprising a polyester fiber. Accordingly, by strategically locating, e.g., the aramid fiber to the vertical section of the mattress, compliance can be achieved with requirements of California Technical Bulletin 603, without, e.g., locating aramid fiber at every location of the flame blocking non-woven needle-punched mattress cover.

Furthermore, some mattress constructions can pass the test while covering the entire mattress with one or the other cover compositions noted above, which may be a function of the nature of the mattress foaming construction (e.g., amount/thickness of the foam).

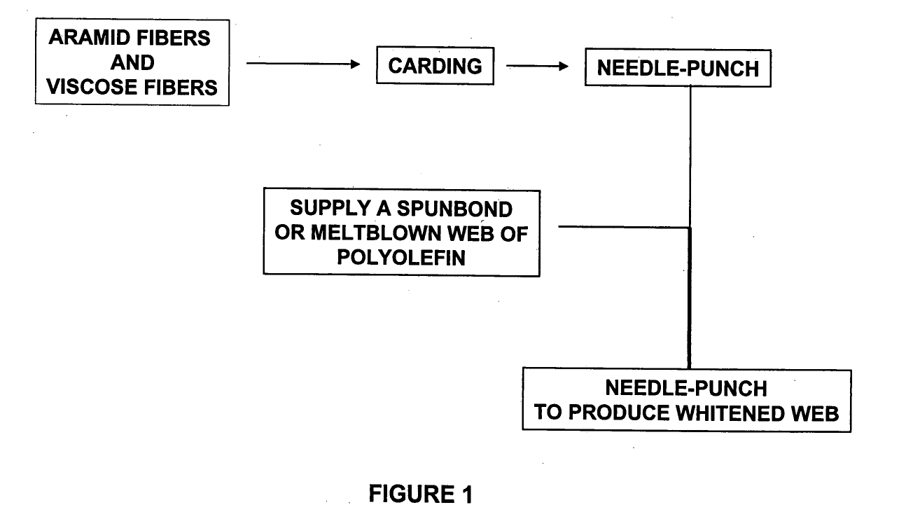

In connection with the manufacture of needle-punched non-woven materials herein, containing aramid fiber, it can be noted that given the inherent yellow color of the aramid fiber, it has been found that certain levels of the aramid, in the non-woven, will cause the non-woven to similarly yellow, thereby providing an undesirable cosmetic effect for a mattress product. Accordingly, it has been found that such undesirable cosmetic feature can be addressed in the fire blocking non-woven structure, containing an aramid fiber, wherein the needle-punched web including the aramid fiber is needle-punched or otherwise attached to a spunbond, a melt blown web or spunbond/meltblown composite material. See, e.g, FIG. 1.

Those of skill in the art will recognize that a spunbond web material is general reference to spunlaid technology in which the filaments have been extruded, drawn and laid on a moving belt to form a web. Accordingly, a polymer suitable for the formation of spunbond material may be introduced into an extruder, output to a spinning die, and collected on a web laydown belt and calender bonded to form a web. In related fashion, a melt blown web material is general reference to a non-woven web forming process that extrudes and draws molten polymer resin with heated, relatively high velocity air to form fine filaments. The filaments are cooled and collected as a web onto a moving belt. While similar to the spunbond process, the melt blown fibers tend to be finer and more generally measured in microns. Accordingly, melt blowing is another form of a spunlaid process.

Accordingly, the spunbond or meltblown materials suitable for needle punching or otherwise attaching to the aramid based non-wovens of the present invention preferably comprises a polyolefin or polyester based material. The objective then is to select that amount of spunbond or meltblown material for combining with the aramid based non-woven web to attenuate the yellow color that is typical for the aramid based web. Accordingly, by attaching a spunbond or melt blown to the aramid based non-woven web, the yellow color of the aramid based web is whitened to provide a more cosmetically pleasing cover for a mattress or other types of foam-containing articles.

In a related embodiment to the above, it has also been found that one can prepare a cosmetically pleasing fire-blocking cover by first supplying a carded web of an aramid based fiber, e.g., a carded web of aramid with a viscose fiber containing silicic acid (e.g., Visil™). Preferably, the amount of aramid fiber in this first carded web is at a level of equal to or greater than 10% (wt.), and preferably, in the range of 10-60% (wt.), including all levels and ranges therebetween. The corresponding amount of viscose fiber is preferably present at a level between 40-90% (wt.), and at all levels and ranges therebetween.

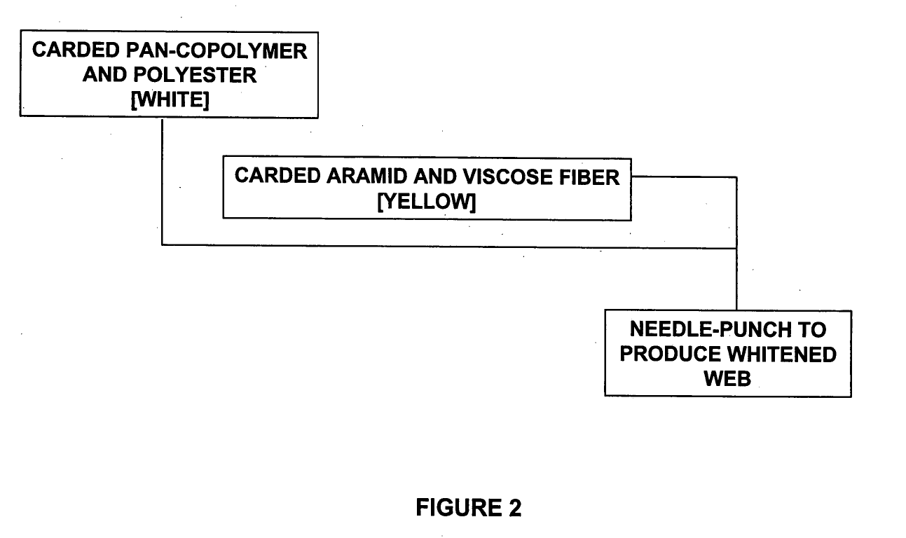

The above is followed by supplying a second carded web comprising a polyacrylonitrile based composition, which composition may preferably include a blend of polyacrylonitrile copolymer containing a halogen comonomer with a polyester polymer such as PET. Preferably, in the case of such blend, the polyacrylonitrile copolymer containing a halogen commoner is present at a level of 70-30% (wt.) and the polyester is present at a level of 30-70% (wt.). The two carded webs may then be needle-punched under conditions wherein the needle-punching is controlled to the point wherein the yellow color of the aramid based carded web is whitened by the incorporation of the polyacrylonitrile web. A summary of the aforementioned process is illustrated in FIG. 2. In addition, in such embodiment, optionally, one may further needle punch with a spunbond or meltblown web of polyolefin or polyester material.

While the invention has been described in detail with reference to specific preferred embodiments, it will be appreciated that various changes and modifications can be made, and equivalents employed, without departing from the scope of the following claims.

1. A fire blocking non-woven needle-punched textile structure, comprising
(a) a first fiber component containing polyacrylonitrile copolymer with a halogen containing monomer;
(b) a second fiber component comprising a viscose fiber containing silicic acid or a regenerated cellulose fiber; and
(c) a third fiber component comprising an aramid fiber, or a melamine/formaldehyde fiber, or a polyester fiber.

2. The fire blocking non-woven needle-punched textile structure of claim 1, wherein said third fiber component comprises an aramid fiber and said aramid fiber is present at a level of less than or equal to about 60.0% (wt.).

3. The fire blocking non-woven needle-punched textile structure of claim 1 wherein said first fiber component is present at a level of about 30-70% (wt.), said second fiber component is present at a level of about 10-50% (wt.), and said third fiber component is present at a level of about 10-30% (wt.).

4. The fire blocking non-woven needle-punched textile structure of claim 1 wherein said aramid fiber is poly(p-phenylene terephthalamide).

5. The fire blocking non-woven needle punched textile structure of claim 1 wherein said polyester fiber is poly(ethylene terephthalate).

6. The fire blocking non-woven needle-punched textile structure of claim 1 wherein said needle-punched non-woven textile structure comprises 1.0-15.0 denier fibers.

7. The fire blocking non-woven needle-punched textile structure of claim 1 wherein said needle punched non-woven textile structure has a basis weight of about 100-350g/m².

8. The fire blocking non-woven needle-punched textile structure of claim 1 wherein said regenerated cellulose fiber is a lyocell fiber.

9. The fire blocking non-woven needle-punched textile structure of claim 1, further including a binder fiber.

10. The fire blocking non-woven needle-punched textile structure of claim 9, wherein said binder fiber comprises a sheath/core, side-by-side or monofilament construction.

11. A fire blocking non-woven needle-punched textile cover structure for a foam-containing article, wherein said article has a substantially vertical panel section and a substantially horizontal panel section, wherein said cover structure includes horizontal and vertical panel cover sections,
wherein said vertical cover section comprises a first fiber component containing polyacrylonitrile copolymer with a halogen containing monomer and a second fiber component comprising a viscose fiber containing silicic acid or melamine/formaldehyde fiber and a third fiber component comprising an aramid fiber; and
wherein said horizontal panel cover section comprises a first fiber component containing polyacrylonitrile copolymer with a halogen containing monomer and a second fiber component comprising a viscose fiber containing silicic acid or melamine/formaldehyde fiber and a third fiber component comprising a polyester fiber.

12. The fire blocking non-woven textile structure of claim 11, wherein said foam containing article is a mattress, sofa cushion or pillow.

13. A fire blocking non-woven needle-punched textile cover structure for a foam-containing article, wherein said article has a substantially vertical panel section and a substantially horizontal panel section, wherein said cover structure includes horizontal and vertical panel cover sections,
wherein said vertical cover section comprises a first carded web including an aramid and/or melamine/formaldehyde fiber and a second carded web comprising a blend of polyacrylonitrile copolymer with a halogen comonomer and a polyester polymer, wherein said first carded web including aramid and/or melamine/formaldehyde fiber is needle punched with said second carded web of said blend; and
wherein said horizontal panel cover section comprises a first fiber component containing polyacrylonitrile copolymer with a halogen containing monomer and a second fiber component comprising a viscose fiber containing silicic acid or melamine/formaldehyde fiber and a third fiber component comprising a polyester fiber.

14. The fire blocking non-woven textile structure of claim 13, wherein said foam containing article is a mattress, sofa cushion or pillow.

15. A fire blocking non-woven textile structure, comprising a needle-punched web including an aramid fiber, wherein said needle punched web including an aramid fiber is attached to a spunbond, melt blown or spunbond/meltblown composite web material.

16. The fire blocking non-woven textile structure of claim 15, wherein said attached spunbond, melt blown or spunbond/meltblown composite web material is attached by needle-punching.

17. The fire blocking non-woven needle punched textile structure of claim 15, wherein said aramid fiber is present at a level of greater than or equal to about 10%, thereby resulting in an initial yellow color, and said spunbond or melt blown web material functions to whiten said yellow color due to said aramid fiber.

18. The fire blocking non-woven needle punched textile structure of claim 15 wherein said spunbond or melt blown web material is a polyolefin or polyester material.

19. The fire blocking non-woven needle punched textile structure of claim 18 wherein said polyolefin is polypropylene.

20. The fire blocking non-woven needle punched textile structure of claim 15, wherein said needle-punched textile web containing said aramid fiber comprises a first fiber component containing polyacrylonitrile copolymer with a halogen containing monomer and a second fiber component comprising a viscose fiber containing silicic acid.

21. A fire blocking non-woven needle-punched textile structure, comprising a first carded web including an aramid and/or melamine/formaldehyde fiber and a second carded web comprising a blend of polyacrylonitrile copolymer with a halogen comonomer and a polyester polymer, wherein said first carded web including aramid and/or melamine/formaldehyde fiber is needle punched with said second carded web of said blend.

22. The fire blocking non-woven needle-punched textile structure of claim 21, wherein said aramid or melamine/formaldehyde fiber in said first carded web is present at a level of greater than or equal to about 10% (wt.).

23. The fire blocking non-woven needle-punched textile structure of claim 21 wherein said second carded web comprises a blend of 30-70% (wt.) of polyacrylonitrile copolymer with a halogen comonomer and 70-30% (wt.) of polyester.

24. The fire blocking non-woven needle-punched textile structure of claim 21 wherein said first carded web comprises 5-25% (wt.) of aramid fiber in combination with 95-75% (wt.) of a viscose fiber containing silicic acid.

25. The fire blocking non-woven needle-punched textile structure of claim 21 wherein said first carded web comprises 5-25% (wt.) of melamine/formaldehyde fiber in combination with 95-75% (wt.) of a viscose fiber containing silicic acid.

26. The fire blocking non-woven needle-punched textile structure of claim 21 wherein said first carded web containing said aramid fiber has a yellow color, and said second carded web functions to whiten said yellow color.

27. A fire blocking non-woven textile structure, comprising a first carded web including an armide fiber and/or a melamine/formaldehyde fiber and a second carded web comprising a blend of binder fiber and a polyester polymer, wherein said first carded web contacts said second carded web of said blend.

28. The fire blocking non-woven textile structure of claim 27 wherein said first carded web comprises 5-25% (wt.) of aramid fiber in combination with 95-75% of a viscose fiber containing silicic acid.

29. The fire blocking non-woven textile structure of claim 27 wherein said first carded web comprises 5-25% (wt.) of melamine/formaldehyde fiber in combination with 95-75% (wt.) of a viscose fiber containing silicic acid.

30. The fire blocking non-woven textile structure of claim 27 wherein said second carded web further includes natural fibers and/or a polyacrylonitrile copolymer with a halogen comonomer.

31. The fire blocking non-woven textile structure of claim 30 wherein said natural fibers comprise wool and/or cotton.
